(19) United States
(12) Patent Application Publication
(10) Pub. No.: US 2018/0179901 A1
(43) Pub. Date: Jun. 28, 2018

(54) TURBINE BLADE WITH CONTOURED TIP SHROUD

(71) Applicant: Siemens Aktiengesellschaft, München (DE)

(72) Inventors: Nicholas F. Martin, Jr., York, SC (US); Andrew S. Lohaus, Berlin (DE)

(21) Appl. No.: 15/739,796

(22) PCT Filed: Jul. 24, 2015
(86) PCT No.: PCT/US2015/041928

§ 371 Date: Dec. 26, 2017

(51) Int. Cl. F01D 5/22; F01D 5/14; F01D 5/28; F01D 11/12

(52) U.S. Cl. CPC F01D 5/225; F01D 5/147; F05D 2250/71; F01D 11/127; F01D 5/143; F01D 5/28

(57) ABSTRACT

A turbine blade (10) includes a generally elongated airfoil (32) extending span-wise along a radial direction, and a circumferentially extending shroud (70) coupled to a radially outer tip (24) of the airfoil (32). The shroud (70) includes an upstream edge (72) and a downstream edge (74) spaced apart axially. The shroud (70) further includes a radially inner surface (76) adjoining the tip (24) of the airfoil (32) and a radially outer surface (78) generally opposite to the radially inner surface (76). The radially inner surface (76) and the radially outer surface (78) are connected at the upstream edge (72) and at the downstream edge (74). In circumferential cross-section, the shroud (70) has a shape of an aerodynamic lifting body (60, 62) defined by a contour of the radially inner surface (76) and that of the radially outer surface (78). The shape of the aerodynamic lifting body (60, 62) is configured such that a radially inward acting lift force (L) is exerted on the shroud (70) by a generally axial fluid flow (F) over the shroud (70).

### BACKGROUND

### 1. Field

This invention relates generally to turbine blades, and in particular to a turbine blade having a tip shroud.

### 2. Description of the Related Art

Typically, gas turbine engines include a compressor for compressing air, a combustor for mixing the compressed air with fuel and igniting the mixture, and a turbine blade assembly for producing power. Combustors often operate at high temperatures that may exceed 2,500 degrees Fahrenheit. Typical turbine combustor configurations expose turbine blade assemblies to these high temperatures. As a result, turbine blades must be made of materials capable of withstanding such high temperatures.

A turbine blade is formed from a root portion coupled to a rotor disc and an elongated airfoil that extends outwardly from a platform coupled to the root portion. The blade is ordinarily composed of a tip opposite the root section, a leading edge, and a trailing edge. The tip of a turbine blade often has a tip feature to reduce the size of the gap between stator segments and blades in the gas path of the turbine to prevent tip flow leakage, which reduces the amount of torque generated by the turbine blades. Some turbine blades include tip shrouds, as shown in FIG. 1, attached to the blade tips. To reduce over-tip leakage, shrouded blades typically include one or more circumferential knife edges for running tight tip gaps. The turbine tip shrouds are also used for the purpose damping blade mechanical vibrations, particularly for blades having high aspect ratio such as those used in lower pressure turbine stages.

Some modern tip shrouds are scalloped, as opposed to a full coverage tip shroud, to reduce shroud weight and hence lower centrifugal pull loads. The material removed by scalloping is indicated by the shaded region in FIG. 1. The removal of material by scalloping increases aerodynamic losses thereby reducing the stage efficiency.

### SUMMARY

An object of the invention is to provide an improved tip shroud for a turbine blade. The object is achieved by the features of the independent claims.

According to a first aspect of the invention, blade for a turbine engine is provided. The blade comprises a generally elongated airfoil extending span-wise along a radial direction of the turbine engine, and a shroud coupled to a tip of the airfoil at a radially outer end of the airfoil and extending generally along a circumferential direction of the turbine engine. The shroud comprises an upstream edge and a downstream edge spaced apart from each other in an axial direction of the turbine engine. The shroud further comprises a radially inner surface adjoining the tip of the airfoil and a radially outer surface generally opposite to the radially inner surface. The radially inner surface and the radially outer surface are connected at the upstream edge and at the downstream edge. In circumferential cross-section, the shroud has a shape of an aerodynamic lifting body defined by a contour of the radially inner surface and a contour of the radially outer surface. The shape of the aerodynamic lifting body is configured such that a radially inward acting lift force is exerted on the shroud by a generally axial fluid flow over the shroud.

The tip shroud is aerodynamically shaped to provide “lift” radially inward which would counteract the centrifugal pull load due to the weight of the tip shroud, during rotation of the turbine blade. This compensation of the centrifugal pull load would allow for a tip shroud with less scalloping, and therefore improved aerodynamic performance.

In one embodiment, to provide the desired radially inwardly directed lift force, the aerodynamic lifting body includes an airfoil-shape comprising a suction side defined by a contour of the radially inner surface, a pressure side defined by a contour of the radially outer surface, a leading edge defined at the upstream edge and a trailing edge defined at the downstream edge. In one embodiment, in circumferential cross-section, the contour of the radially inner surface is more convex than that of the radially outer surface. In the illustrated embodiments, the radial thickness of the shroud defined between the radially inner surface and the radially outer surface is greater toward the upstream edge and lesser toward the downstream edge. In particular, it may be preferred that the upstream edge of the shroud is rounded while the downstream edge of the shroud is sharp or pointed.

In one embodiment, the aerodynamic lifting body is shaped such that the contour of the radially outer surface includes a substantially straight ramp, the upstream edge being positioned further radially inward than the downstream edge, wherein the radially inner surface and the radially outer surface are inclined with respect to each other, defining a sharp edge at the downstream edge and a rounded edge at the upstream edge. The embodiment provides a basic aerodynamic lifting body while maintaining a conical shaped flow path at the tip of the airfoil. In a further embodiment, a knife edge seal is positioned on the radially outer surface of the shroud, the knife edge seal extending radially outward from the radially outer surface of the shroud to run a tight gap with a stator component comprising a honeycomb structure.

In an alternate embodiment, the aerodynamic lifting body is cambered, with the contour of the radially inner surface being generally convex, the contour of the radially outer surface being generally concave and the downstream edge of the shroud being positioned further radially outward than the upstream edge of the shroud, wherein the downstream edge of the shroud forms a tip gap seal running a tight gap with a stator component. The embodiment replaces the knife edge seal and may obviate the need for honeycomb structures in the stator, thereby reducing cost and complexity of design. The embodiment may also allow for increased tip shroud area on the blade tip.

In one embodiment, the shape of the aerodynamic lifting body in circumferential cross-section varies along the circumferential direction. The tip shroud forms a radially outer end-wall of the blade. Extending the aerodynamic shaping of the tip shroud in the circumferential direction allows for end-wall contouring for the outer diameter flow path defined by the tip shroud. End-wall contouring allows improved control of the flow cross-section between adjacent blades, leading to improved aerodynamic performance.

To provide an effective tip gap seal, a radial height of the downstream edge of the shroud is substantially constant along the circumferential direction. As a result of the contouring in the circumferential direction, a radial height of the upstream edge of the shroud may vary along the circumferential direction.

In one embodiment, the shroud entirely covers the tip of the airfoil, wherein an axial position of the downstream edge and an axial position of the upstream edge are both substantially constant along the circumferential direction. The embodiment provides a full coverage (or un-scalloped) tip shroud. A full coverage tip shroud provides improved aerodynamic characteristics by reducing parasitic leakage, which improves stage efficiency.

In an alternate embodiment, for further reduction of the centrifugal pull load, the upstream edge and/or the downstream edge of the shroud are scalloped along the circumferential direction, thereby reducing shroud weight. In this case, respectively, an axial position of the upstream edge and/or an axial position of the downstream edge vary in the circumferential direction.

In one embodiment, the tip of the airfoil is profiled to match the contour of the radially inner surface of the shroud.

According to a second aspect of the invention, a turbine stage is provided. The turbine stage comprises a circumferential row of blades spaced apart to define respective flow passages therebetween for channeling a working fluid, and a stator component disposed coaxially around the circumferential row of blades. Each blade comprises a generally elongated airfoil extending span-wise radially outward from a respective platform, and a shroud coupled to a tip of the airfoil at a radially outer end of the airfoil and extending generally along a circumferential direction. The shroud of each blade comprises an upstream edge and a downstream edge spaced apart from each other in an axial direction. Each shroud further comprises a radially inner surface adjoining the tip of the airfoil and a radially outer surface generally opposite to the radially inner surface, the radially inner surface and the radially outer surface being connected at the upstream edge and at the downstream edge. In circumferential cross-section, each shroud has a shape of an aerodynamic lifting body defined by a contour of the radially inner surface and a contour of the radially outer surface. The shape of the aerodynamic lifting body is configured such that a radially inward acting lift force is exerted on the shroud by a generally axial flow of the working fluid over the shroud. The shrouds of adjacent blades adjoin circumferentially next to each other to define a shroud ring, in which the shape of the aerodynamic lifting body in circumferential cross-section varies in a periodic pattern in the circumferential direction between adjacent airfoils.

The above aspect combines at least two inventive features: First, the tip shroud is aerodynamically shaped to provide “lift” radially inward which would counteract the centrifugal pull during rotation of the turbine blade. This compensation of the centrifugal pull load would allow for a tip shroud with less scalloping, and therefore improved aerodynamic performance. Second, the aerodynamic shaping of the tip shroud is extended in the circumferential direction, allowing for end-wall contouring for the outer diameter flow path defined by the tip shroud. End-wall contouring allows improved control of the flow cross-section between adjacent blades, leading to improved aerodynamic performance.

### BRIEF DESCRIPTION OF THE DRAWINGS

The invention is shown in more detail by help of figures. The figures show preferred configurations and do not limit the scope of the invention.

FIG. 1 is a perspective view of a conventional turbine airfoil with a tip shroud,

FIG. 2 is a perspective view of a gas turbine engine with a row of shrouded turbine blades wherein embodiments of the present invention may be incorporated,

FIG. 3 is a schematic radial top view of a shrouded blade according to one embodiment,

FIG. 4 is a schematic circumferential cross-sectional view of a tip shroud along the section A-A in FIG. 3, defining an aerodynamic lifting body according to a first embodiment,

FIG. 5 is a schematic circumferential cross-sectional view of a shroud along the section A-A in FIG. 3, defining an aerodynamic lifting body according to a second embodiment,

FIG. 6 schematically illustrates a variation of the cross-sectional shape of the tip shroud at two different sections spaced apart the circumferential direction according to a further embodiment,

FIG. 7 shows an axial view looking aft taken along the section C-C in FIG. 3, schematically illustrating a periodic variation of the shape of the tip shroud along a circumferential direction according to one aspect of the present invention, and

FIG. 8 schematically illustrates a variation of the cross-sectional shape of a scalloped tip shroud at two different sections along the circumferential direction, according to a further embodiment.

### DETAILED DESCRIPTION

In the following detailed description of the preferred embodiment, reference is made to the accompanying drawings that form a part hereof, and in which is shown by way of illustration, and not by way of limitation, a specific embodiment in which the invention may be practiced. It is to be understood that other embodiments may be utilized and that changes may be made without departing from the spirit and scope of the present invention.

A gas turbine engine may comprise a compressor section, a combustor and a turbine section. The compressor section compresses ambient air. The combustor combines the compressed air with a fuel and ignites the mixture creating combustion products comprising hot gases, that form a working fluid. The working fluid travels to the turbine section. Within the turbine section are circumferential rows of vanes and blades, the blades being coupled to a rotor. Each pair of rows of vanes and blades forms a stage in the turbine section. The turbine section comprises a fixed turbine casing, which houses the vanes, blades and rotor.

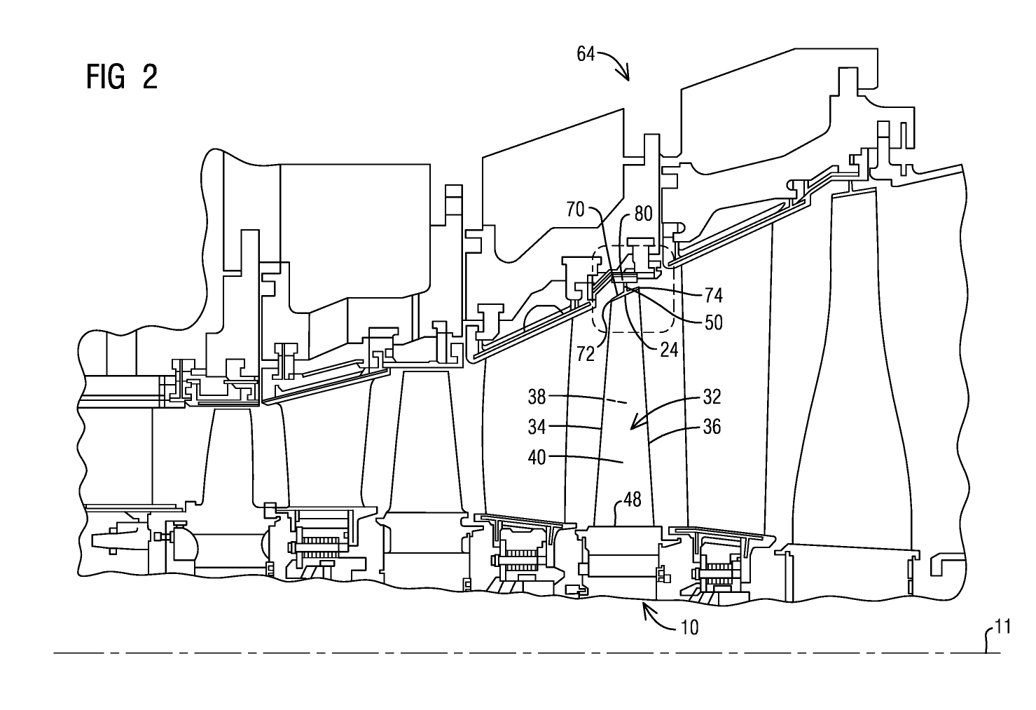

Referring now to FIG. 2, a portion of a turbine section of a gas turbine engine 64 is shown, which comprises a row of turbine blades 10 wherein embodiments of the present invention may be incorporated. The blades 10 are circumferentially spaced apart from each other to define respective flow passages between adjacent blades 10, for channeling the working fluid. The blades 10 are rotatable about a rotation axis along the centerline 11 of the turbine engine 64. Each blade 10 is formed from a generally elongated airfoil 32 extending span-wise in a radial direction in the turbine engine 64 from a rotor disc. The airfoil 32 includes a leading edge 34, a trailing edge 36, a pressure side 38, a suction side 40 on a side opposite to the pressure side 38, a tip 24 at a radially outer end of the airfoil 32, a platform 48 coupled to the airfoil 32 at a radially inner end of the airfoil 32 for supporting the airfoil 32 and for coupling the airfoil 32 to the rotor disc. The blade 10 further includes a shroud 70, referred to as tip shroud, coupled to the tip 24 of the generally elongated airfoil 32. The platform 48 forms a radially inner end-wall, while the shroud 70 forms a radially outer end-wall of the blade 10.

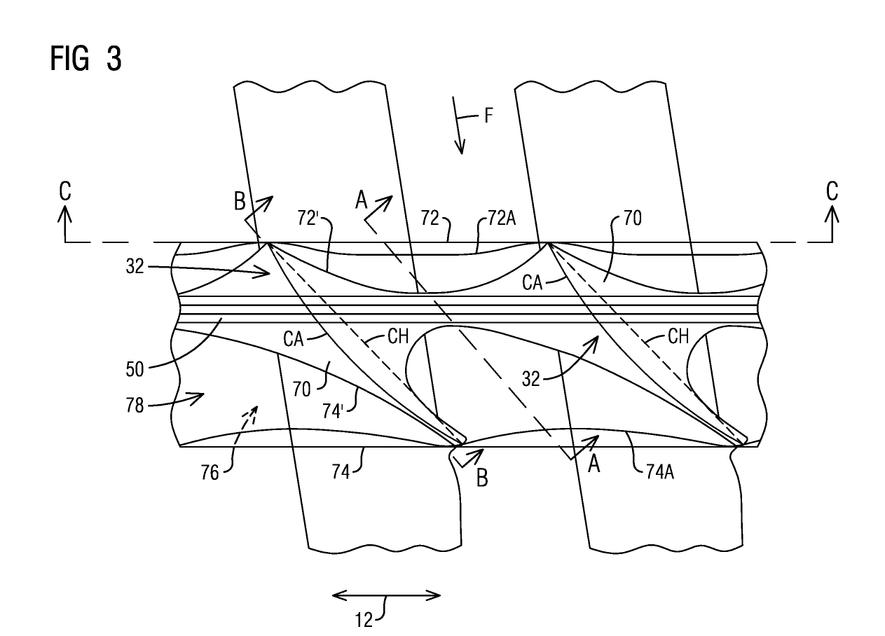

FIG. 3 shows a schematic top view, looking radially inward, of a shrouded turbine blade 10 according to one embodiment. The shroud 70 comprises a radially outer surface 78 and a radially inner surface 76 generally opposite to the radially outer surface 78. The tip 24 of the airfoil 32 (not shown in FIG. 3) adjoins the radially inner surface 76. The curve CA represents a mean camber line at the tip 24 of the airfoil 32, which is defined as a curve that is equidistant from the suction side 40 and the pressure side 38 at the tip 24 of the airfoil 32. The line CH represents a tip chord of the airfoil 32, which is defined as a straight line connecting leading edge 34 and the trailing edge 36 at the tip 24 of the airfoil 32.

As shown in FIG. 3, the shroud 70 extends along a circumferential direction 12. The shrouds 70 of adjacent blades 10 adjoin in the circumferential direction 12 to form a shroud ring. In one embodiment, a knife edge seal 50 may be provided on the shroud 70, extending radially outward from the radially outer surface 78 of the shroud 70. The knife edge seal 50 further extends in a circumferential direction of the turbine engine 64 and runs a tight tip gap against a stator component 80 of the turbine engine 64 arranged coaxially around the circumferential row of blades 10, thereby reducing overtip leakage. In this case, the stator component 80 may comprise a honeycomb structure.

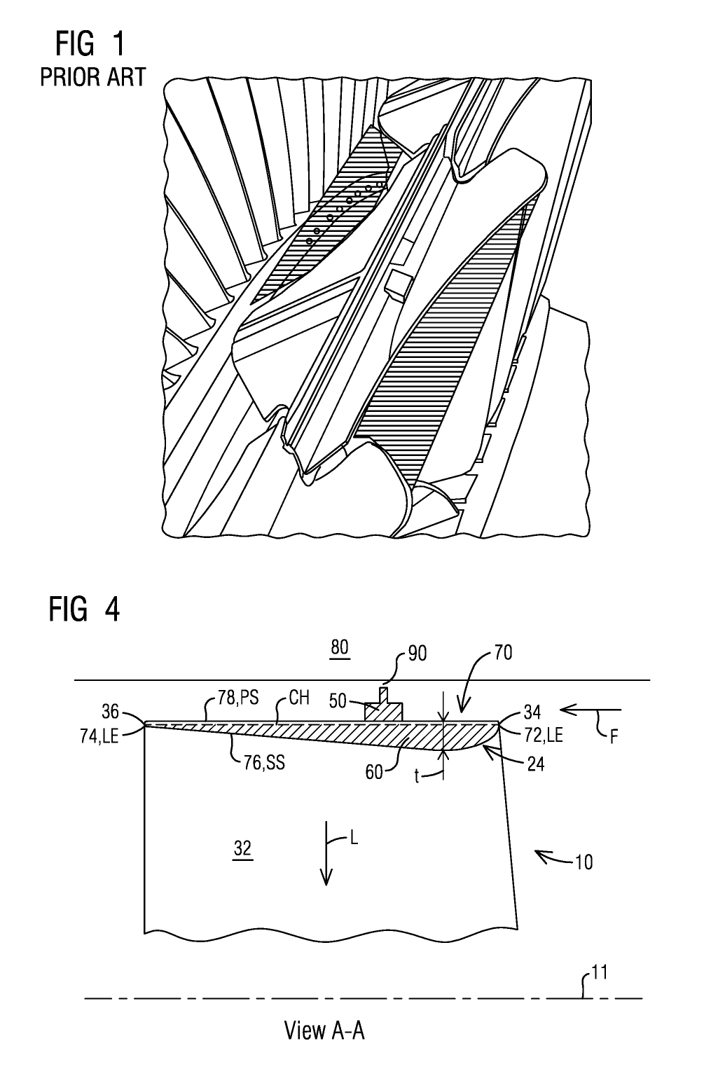

As shown in FIG. 3, the shroud 70 comprises an upstream edge 72 and a downstream edge 74 defined with respect to a generally axial flow of the working fluid, indicated as F. The upstream edge 72 and the downstream edge 74 are thereby spaced apart in the axial direction in the turbine engine. The radially inner surface 76 and the radially outer surface 78 are connected at the upstream and downstream edges 72 and 74. In the illustrated embodiment, the shroud 70 entirely covers the tip chord CH of the airfoil 32, and furthermore, the axial position of the upstream edge 72 and the axial position of the downstream edge 74 are both substantially constant along the circumferential direction 12. That is to say, in the embodiment, the shroud 70 is a full coverage tip shroud, with the upstream and downstream edges 72 and 74 extending essentially parallel to each other in the circumferential direction 12. This is in contrast to a scalloped tip shroud as currently used, particularly in low pressure turbine stages, wherein the upstream and downstream edges have heavily scalloped contours along the circumferential direction 12, as indicated by the contours 72′ and 74′ respectively in FIG. 3 (also seen in FIG. 1). The scalloping of the tip shroud may involve removal of material from a full coverage tip shroud to reduce centrifugal pull loads caused by the weight of the shroud. However, a heavily scalloped tip shroud, such as illustrated above, may increase parasitic tip leakage and may further distort the streamlines in the outer diameter flow path of the working fluid, increasing aerodynamic losses thereby reducing the stage efficiency.

Embodiments of the present invention provide an inventive technique for reducing centrifugal pull loads on a shrouded turbine blade without necessarily reducing the weight of the tip shroud significantly, as in case of the aforementioned scalloped design. As per the embodiments, the above technical effect is achieved by shaping the shroud 70 in circumferential cross-section to have the shape of an aerodynamic lifting body, as defined by the contour of the radially inner surface 76 and the contour of the radially outer surface 78. The shape of aerodynamic lifting body may be configured in several ways, as exemplified in FIGS. 4, 5, 6 and 8, with the underlying feature of each shape being that a radially inward acting aerodynamic lift force L is exerted on the shroud 70 by a generally axial flow F of the working fluid over the shroud 70. In the illustrated embodiments, the radially inward acting aerodynamic lift force counteracts the radially outward acting centrifugal pull load resulting from the weight of the shroud 70 when the blade 10 rotates about the axis 11. This obviates the need for a heavily scalloped design of the shroud 70. For example, in one embodiment, the inventive concepts may be applied to a full coverage tip shroud, which, in turn, would provide reduced aerodynamic losses and increases stage efficiency.

Referring now to FIG. 4, a first embodiment of a tip shroud having an aerodynamic circumferential cross-sectional shape is illustrated. The view shown in

FIG. 4 is a schematic cross-section along a sectional plane A-A in FIG. 3. As may be understood, the sectional plane A-A is parallel to the tip chord CH of the respective airfoil and cuts radially through the shroud 70. In this embodiment, an aerodynamic lifting body 60 is defined by the contour of the radially inner surface 76 and the contour of the radially outer surface 78. During operation of the turbine engine 64, the working fluid flows over the aerodynamic lifting body 60 in a generally axial flow direction F, exerting an aerodynamic force on the aerodynamic lifting body 60 that may be resolved into parallel and perpendicular components with respect to the flow direction F. The aerodynamic lifting body 60 is configured such that the perpendicular component of the aerodynamic force, referred to as the lift force L, is directed generally radially inward toward the centerline 11 of the engine, as shown in FIG. 4. To this end, the aerodynamic lifting body 60 comprises an airfoil shape, in which a suction side SS is defined by the contour of the radially inner surface 76, a pressure side PS is defined by a contour of the radially outer surface 78, a leading edge LE is defined at the upstream edge 72 and a trailing edge TE is defined at the downstream edge 74.

In the embodiment of FIG. 4, the contour of the radially outer surface 78 includes a substantially straight ramp, such that the upstream edge 72 is positioned further radially inward than the downstream edge 74. Furthermore, the radially inner surface 76 and the radially outer surface 78 are inclined with respect to each other, defining a sharp edge at the downstream edge 74 and a rounded edge at the upstream edge 72. The embodiment provides a basic aerodynamic lifting body while maintaining a conical shaped flow path at the tip 24 of the airfoil 32. A feature of this shape is that it involves minimum or no modification to the existing profile of the tip 24 of the airfoil 32. Furthermore, in this embodiment, a knife edge seal 50 may be arranged extending radially outward from the radially outer surface 78 to run a tight gap 90 with the stator component 80 that may comprise a honeycomb structure. The axial position of the knife edge seal 50 may be adjusted to provide an optimal sealing location. An optimal sealing location may be determined, for example, based on considerations such as minimizing mechanical imbalances in the blade arising from the modified circumferential cross-sectional shape of the shroud 70. In a further embodiment, the shape of the shroud 70 in circumferential cross-section may not be constant, but may vary along the circumferential direction of the shroud 70. In such a case, the aerodynamic lifting body 60 may have a different shape along the sectional plane A-A than, for example, along the sectional plane B-B, which is parallel to and circumferentially spaced apart from the plane A-A (see FIG. 3).

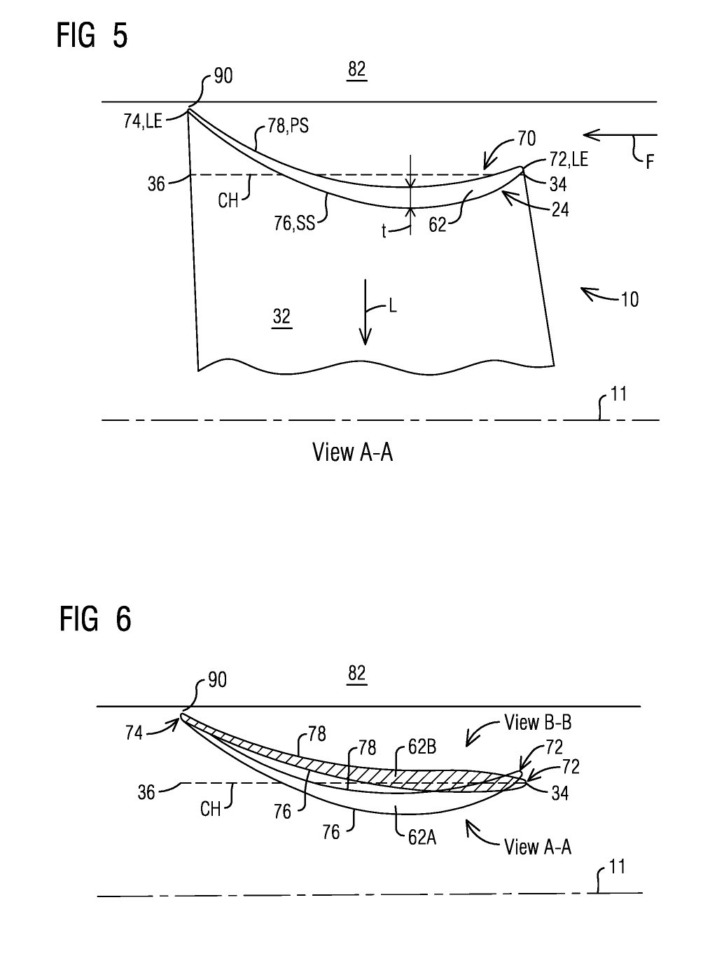

Referring to FIG. 5, a second embodiment of a tip shroud having an aerodynamic circumferential cross-sectional shape is illustrated. The cross-section shown in FIG. 5 is along the sectional plane A-A in FIG. 3. In this case, the contour of the radially inner surface 76 and the contour of the radially outer surface 78 define an aerodynamic lifting body 62 having a cambered shape. In this example, the contour of the radially inner surface 76 is generally convex and the contour of the radially outer surface 78 is generally concave. This embodiment may require the tip 24 of the airfoil 32 to be profiled to match the convex contour of the radially inner surface 76 of the shroud 70. It should be noted that the view in FIG. 5 is schematic, wherein the camber is exaggerated for illustrative purposes. The aerodynamic lifting body 62 thus comprises an airfoil shape, in which a suction side SS is defined by the contour of the radially inner surface 76, a pressure side PS is defined by a contour of the radially outer surface 78, a leading edge LE is defined at the upstream edge 72 and a trailing edge TE is defined at the downstream edge 74. The shape of the aerodynamic lifting body 62 ensures that an axial flow F of the working fluid over the shroud 70 exerts a radially inward aerodynamic lift force L, directed towards the centerline 11 of the engine.

In general, as shown in the examples of FIGS. 4 and 5, to achieve a radially inward lift force L, in circumferential cross-section, the contour of the radially inner surface 76 may be shaped more convex than that of the radially outer surface 78. Furthermore, a radial thickness t of the shroud 70 defined between the radially inner surface 76 and the radially outer surface 78 may be preferably greater toward the upstream edge 72 and lesser toward the downstream edge 74, to define a rounded leading edge and a sharp trailing edge.

In the embodiment of FIG. 5, the downstream edge 74 of the shroud 70 is positioned further radially outward than the upstream edge 72 of the shroud 70, such that the downstream edge 74 forms a tip gap seal running a tight gap 90 with a stator component 82. The embodiment may eliminate the knife edge seal, and may consequently obviate the need for honeycomb structures in the stator, thereby reducing cost and complexity of design. The stator component 82 in this case may comprise a smooth wall, for example having a ceramic rub zone, or alternately, a honeycomb structure, that interfaces with the downstream edge 74 of the shroud 70 via the tip gap 90.

In a further embodiment, the cross-sectional shape of the shroud may vary along the circumferential direction. In particular, a variation in camber (i.e., asymmetry between the suction and pressure sides) of the aerodynamic lifting body may be provided along the circumferential direction, as schematically shown in FIG. 6. FIG. 6 shows the shapes of the aerodynamic lifting body 62A, 62B at two different circumferential locations, respectively along the sectional planes A-A and B-B of FIG. 3. The sectional plane B-B cuts radially through the shroud 70 along the tip chord CH of the airfoil. The sectional plane A-A is parallel to the plane B-B and is circumferentially spaced apart from the plane B-B. The airfoil 32 is not shown in FIG. 6 for clarity. In this embodiment, the shroud 70 is a full coverage tip shroud, such that a constant axial position is maintained for the upstream edge 72 and for the downstream edge 74 along the circumferential direction. Furthermore, since the downstream edge 74 of the shroud 70 is used as a tip gap seal, the radial height of the downstream edge is maintained constant in the circumferential direction for effective tip gap sealing. The variation in camber may be achieved by varying the radial height of the upstream edge 72 along the circumferential direction.

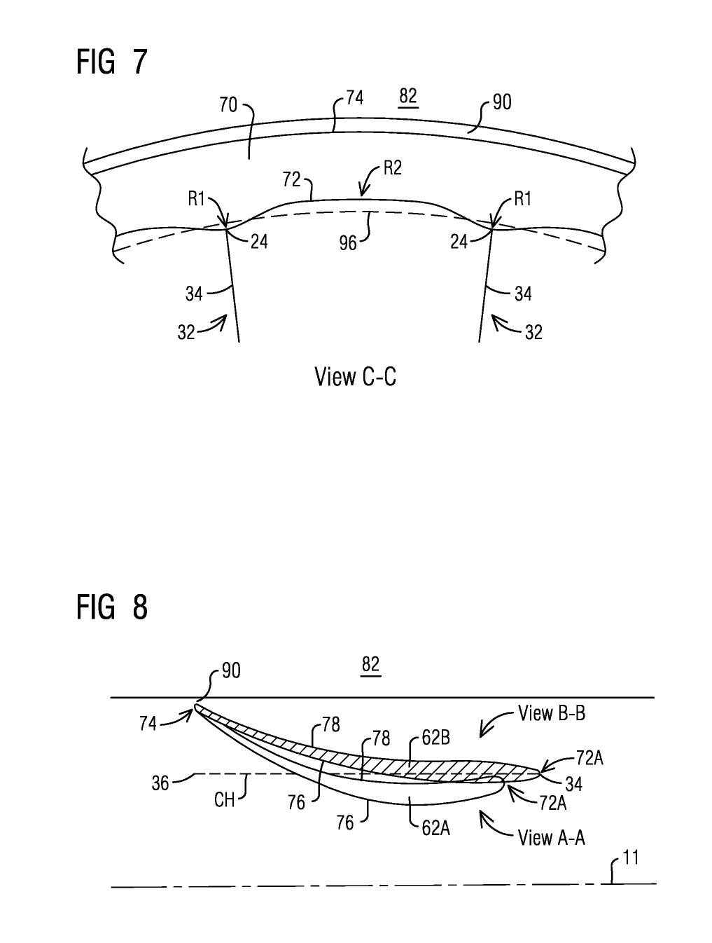

In one embodiment, the shape of the aerodynamic lifting body 62 in circumferential cross-section varies in a periodic pattern in the circumferential direction between adjacent airfoils 32. The periodic variation is schematically illustrated in an axial view shown in FIG. 7, taken along the section C-C in FIG. 3. As shown, the downstream edge 74 of the shroud 70 has a fixed radial height, while the radial height upstream edge 72 varies in periodic pattern between circumferentially adjacent airfoils 32, only the leading edges 34 of which are shown in FIG. 7. In particular, the contour of the upstream edge 72 in the circumferential direction 12 comprises radially inward peaks R1 and radially outward valleys R2 in periodic pattern between adjacent airfoils 32. The peaks R1 are radially aligned with the tips 24 of the airfoils 32, while the valleys R2 occupy intermediate positions between circumferentially adjacent airfoils 32. Extending the aerodynamic shaping of the shroud 70 in the circumferential direction allows for end-wall contouring for the outer diameter flow path defined by the shroud 70. End-wall contouring allows improved control of the flow cross-section between adjacent airfoils 32, leading to improved aerodynamic performance. The dashed line 96 indicates the radial position of the tips 24 of the airfoil in the absence of the end-wall contouring of the present embodiment.

In one embodiment, in contrast to a full coverage tip shroud, the shroud may be scalloped at the upstream edge and/or at the downstream edge along the circumferential direction. This is illustrated in FIG. 3, wherein a scalloped upstream edge is indicated as 72A and a scalloped downstream edge is indicated as 74A. In case of a scalloped upstream edge 72A, the axial position of the upstream edge 72A varies in the circumferential direction 12. Likewise for a scalloped downstream edge 74A, the axial position of the downstream edge 74A varies in the circumferential direction 12. Scalloping of the upstream and/or downstream edge may be done for weight reduction, to further limit centrifugal pull loads. However, it is to be noted that even in case of a scalloped design, the amount of scalloping may be significantly reduced on account of the compensation of the centrifugal pull loads by the radially inward aerodynamic lift provided by the circumferential cross-sectional shape of the shroud 70.

In a further embodiment, a circumferential variation of camber may be extended to a scalloped shroud, as schematically illustrated in FIG. 8. In the shown embodiment, the shroud 70 is scalloped only at the upstream edge 72A. FIG. 8 shows the shapes of the aerodynamic lifting body 62A, 62B at two different circumferential locations, respectively along the parallel sectional planes A-A and B-B in FIG. 3, the sectional plane B-B cutting radially through the shroud 70 along the tip chord CH of the airfoil. The airfoil 32 is not shown in FIG. 8 for clarity. As shown, the axial position of the scalloped upstream edge 72A varies between the plane B-B and the plane A-A. Referring to FIGS. 3 and 8, the axial position of the scalloped upstream edge 72A may vary in periodic pattern between circumferentially adjacent airfoils 32. The axial position of the un-scalloped downstream edge 74 remains substantially constant. In addition, end-wall contouring may be achieved by varying the radial height of the scalloped upstream edge 72A along the circumferential direction. The radial height of the downstream edge 74 remains constant to maintain effective tip gap sealing.

In other embodiments, instead of or in addition to the upstream edge 72A being scalloped, the downstream edge 74A may be scalloped. This would require additional camber changes to maintain a fixed radius of the downstream edge. A scalloped downstream edge 74A would no longer be at a constant axial position, but would vary in axial position in a periodic pattern between adjacent airfoils 32 as shown in FIG. 3.

The tip 24 of the airfoil 32 may be profiled to match the contour of the radially inner surface 76 of the shroud 70. In one embodiment, the inventive shroud 70 may be cast integrally with the airfoil 32, for example, using a ceramic casting core.

While specific embodiments have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. A blade or a turbine engine comprising:
a generally elongated airfoil extending span-wise along a radial direction, and a shroud coupled to a tip of the airfoil at a radially outer end of the airfoil and extending generally along a circumferential direction, the shroud comprising:
an upstream edge and a downstream edge spaced apart from each other in an axial direction,
a radially inner surface adjoining the tip of the airfoil and a radially outer surface generally opposite to the radially inner surface, the radially inner surface and the radially outer surface being connected at the upstream edge and at the downstream edge,
wherein in circumferential cross-section, the shroud has a shape of an aerodynamic lifting body defined by a contour of the radially inner surface and a contour of the radially outer surface, the shape of the aerodynamic lifting body being configured such that a radially inward acting lift force is exerted on the shroud by a generally axial fluid flow over the shroud.

2. The blade according to claim 1, wherein the shape of the aerodynamic lifting body includes an airfoil-shape comprising a suction side defined by a contour of the radially inner surface, a pressure side defined by a contour of the radially outer surface, a leading edge defined at the upstream edge and a trailing edge defined at the downstream edge.

3. The blade according to claim 1, wherein in circumferential cross-section, the contour of the radially inner surface is more convex than that of the radially outer surface.

4. The blade according to claim 1, wherein a radial thickness of the shroud defined between the radially inner surface and the radially outer surface is greater toward the upstream edge and lesser toward the downstream edge.

5. The blade according to claim 1, wherein the aerodynamic lifting body is shaped such that:
the contour of the radially outer surface includes a substantially straight ramp, the upstream edge being positioned further radially inward than the downstream edge, and
the radially inner surface and the radially outer surface are inclined with respect to each other, defining a sharp edge at the downstream edge and a rounded edge at the upstream edge.

6. The blade according to claim 1, wherein a knife edge seal is positioned on the radially outer surface of the shroud, the knife edge seal extending radially outward from the radially outer surface of the shroud to run a tight gap with a stator component comprising a honeycomb structure.

7. The blade according to claim 1, wherein the aerodynamic lifting body is cambered, such that:
the contour of the radially inner surface is generally convex and the contour of the radially outer surface is generally concave, with the downstream edge of the shroud being positioned further radially outward than the upstream edge of the shroud, and
wherein the downstream edge of the shroud forms a tip gap seal running a tight gap with a stator component.

8. The blade according to claim 1, wherein the shape of the aerodynamic lifting body in circumferential cross-section varies along the circumferential direction.

9. The blade according to claim 7, wherein a radial height of the downstream edge of the shroud is substantially constant along the circumferential direction.

10. The blade according to claim 7, wherein a radial height of the upstream edge of the shroud varies along the circumferential direction.

11. The blade according to claim 1, wherein the shroud entirely covers the tip of the airfoil, and wherein an axial position of the downstream edge and an axial position of the upstream edge are both substantially constant along the circumferential direction.

12. The blade according to claim 1, wherein the upstream edge and/or the downstream edge of the shroud are scalloped along the circumferential direction, and
wherein, respectively, an axial position of the upstream edge and/or an axial position of the downstream edge vary in the circumferential direction.

13. The blade according to claim 1, wherein the tip of the airfoil is profiled to match the contour of the radially inner surface of the shroud.

14. A turbine stage comprising:
a circumferential row of blades spaced apart to define respective flow passages therebetween for channeling a working fluid, and
a stator component disposed coaxially around the circumferential row of blades,
wherein each blade comprises a generally elongated airfoil extending span-wise radially outward from a platform, and
a shroud coupled to a tip of the airfoil at a radially outer end of the airfoil and extending generally along a circumferential direction, the shroud of each blade comprising:
an upstream edge and a downstream edge spaced apart from each other in an axial direction,
a radially inner surface adjoining the tip of the airfoil and a radially outer surface generally opposite to the radially inner surface, the radially inner surface and the radially outer surface being connected at the upstream edge and at the downstream edge,
wherein in circumferential cross-section, the shroud of each blade has a shape of an aerodynamic lifting body defined by a contour of the radially inner surface and a contour of the radially outer surface, the shape of the aerodynamic lifting body being configured such that a radially inward acting lift force is exerted on the shroud by a generally axial flow of the working fluid over the shroud,
wherein the shrouds of adjacent blades adjoin circumferentially next to each other to define a shroud ring, in which the shape of the aerodynamic lifting body in circumferential cross-section varies in a periodic pattern in the circumferential direction between adjacent airfoils.

15. The turbine stage according to claim 14, wherein in circumferential cross-section, the aerodynamic lifting body is cambered, such that:
the contour of the radially inner surface is generally convex and the contour of the radially outer surface is generally concave, with the downstream edge of the shroud being positioned further radially outward than the upstream edge of the shroud, and
wherein the downstream edge of the shroud forms a tip gap seal running a tight gap with the stator component.

16. The turbine stage according to claim 15, wherein the downstream edge has a constant radial height in the circumferential direction between adjacent airfoils.

17. The turbine stage according to claim 15, wherein a radial height of the upstream edge varies in a periodic pattern in the circumferential direction between adjacent airfoils.

18. The turbine stage according claim 17, wherein a contour of the upstream edge in the circumferential direction comprises radially inward peaks and radially outward valleys periodic pattern between adjacent airfoils, the peaks being radially aligned with the tips of the airfoils.

19. The turbine stage according to claim 15, wherein the stator component comprises a smooth wall, and
wherein downstream edge runs a tight gap with the smooth wall.

20. The turbine stage according to claim 15, wherein the stator component comprises a honeycomb structure,
and wherein the downstream edge runs a tight tip gap with the honeycomb structure.
